(19) United States
(12) Patent Application Publication
(10) Pub. No.: US 2007/0094595 A1
(43) Pub. Date: Apr. 26, 2007

(54) Survey portal system and method of use

(76) Inventors: Mathew W. Heck, Rolling Meadows, IL (US); Karen Barbera, Naperville, IL (US); Ryan Bautista, Streamwood, IL (US); Glen Gerhardt, Hoffman Estates, IL (US)

Correspondence Address: MCANDREWS HELD & MALLOY, LTD, 500 WEST MADISON STREET, SUITE 3400, CHICAGO, IL, 60661, US

(21) Appl. No.: 11/253,442

(22) Filed: Oct. 18, 2005

(51) Int. Cl. G06F 3/00; G07G 1/00

(52) U.S. Cl. 715/700; 705/10

(57) ABSTRACT

Certain embodiments of the present invention provide a system and method for providing assessment content and services via a portal. Certain embodiments provide an assessment content and services portal. The portal includes an interface for access to assessment content at a portal, an administration engine for managing the portal, assessment content made available to a user via the interface at the portal, and a report generator for generating reports based on the assessment content. The portal may be a web-based portal, for example. In an embodiment, the administration engine facilitates configuration, access permission, content construction, and/or report construction, for example. In an embodiment, the interface is customized based on organization, user, and/or content, for example. The assessment content may include a survey, a test, a review, and/or a feedback questionnaire, for example. The assessment content may also include informational resources, such as best practices.

### BACKGROUND OF THE INVENTION

The present invention generally relates to a survey portal. More specifically, the present invention relates to a survey portal for facilitating survey configuration, administration and reporting.

Many organizations value surveys, such as employee evaluation and satisfaction surveys. Organizations use employee surveys to judge performance and award promotions, for example. Organizations also use customer satisfaction surveys to gauge success of products or services and determine improvements. Managers may also be evaluated by employees using surveys.

Surveys may help initiate changes in a workplace environment, product or service improvements, and employee training, for example. Survey results may influence major strategic decisions by a corporation. Current survey systems do not provide a rapid response to help in making important, timely business decisions. Additionally, current survey systems are not easily accessible on demand.

Additionally, organizations use tests, such as competency or other qualification (knowledge-based or performance) tests, to evaluate candidates for employment, promotion, reward, etc. However, current testing systems require extensive administrator involvement resulting in a significant time commitment to administer tests to a group of people. Both current handwritten and computerized tests involve significant set-up, monitoring, and scoring efforts by the test administrator and support personnel. Furthermore, current testing systems provide minimal security and leave an opportunity for a user to copy information from or interfere with a testing session.

Furthermore, current survey and testing resources are usually provided on a standalone basis and often in a plurality of fragmented components. Additionally, survey and testing resources are often unsecure. Organizations must also currently invest significant time and resources to administer and analyze survey and other assessment content.

Therefore, a system and method that provide centralized access to assessment-related content and/or services via a portal would be highly desirable. A system and method that facilitate management and/or organization of resources via a portal would also be highly desirable. Additionally, a system and method providing assessment administration and reporting via a portal would be highly desirable.

### BRIEF SUMMARY OF THE INVENTION

Certain embodiments of the present invention provide a system and method for providing assessment content and services via a portal. Certain embodiments provide an assessment content and services portal. The portal includes an interface for access to assessment content at a portal, an administration engine for managing the portal, assessment content made available to a user via the interface at the portal, and a report generator for generating reports based on the assessment content. The portal may be a web-based portal, for example.

In an embodiment, the administration engine facilitates configuration, access permission, content construction, and/or report construction, for example. In an embodiment, the interface is customized based on organization, user, and/or content, for example. The assessment content may include an organizational survey, a multi-rater assessment, a test, a review, and/or a feedback questionnaire, for example. The content may also include informational resources, such as best practices.

Certain embodiments provide a method for providing assessment content using a portal. The method includes gathering assessment content for access via a centralized access portal, facilitating access to the assessment content via the centralized portal, and generating real-time reporting related to the assessment content for retrieval via the centralized portal. In an embodiment, the assessment content includes survey content, test content, review content, and/or feedback content, for example. The centralized portal may include a portal customized for an organization, for example. In an embodiment, the portal includes a web-based portal.

In an embodiment, the method further includes controlling accessing to the centralized portal based on at least one criterion, such as user, role, organization, and/or content. In an embodiment, assessment content is organized according to a hierarchy. The hierarchy may include multiple views and/or multiple hierarchies.

Certain embodiments provide a computer-readable medium having a set of instruction for execution on a computer. The set of instructions includes a portal routine configured to coordinate access to assessment content through a centralized access portal, a content routine configured to provide assessment content to an authorized user via the portal, a reporting routine configured to generate a report based on the assessment content via the portal, and an administration routine configured to allow management of the assessment content via the portal. The assessment content may include survey content, test content, review content, feedback content, and/or informational resources, for example.

In an embodiment, the administration routine allows an authorized user to set one or more privilege levels granting varying levels of access. In an embodiment, the administration routine controls access to the portal based on user, role, organization, and/or content, for example. In an embodiment, the administration routine configures the assessment content according to at least one hierarchy and at least one view.

### BRIEF DESCRIPTION OF SEVERAL VIEWS OF THE DRAWINGS

FIG. 1 illustrates a survey portal in accordance with an embodiment of the present invention.

FIG. 2 depicts an example of a report warehouse for viewing and/or downloading reports via the portal in accordance with an embodiment of the present invention.

FIG. 3 illustrates an example of a portal in accordance with an embodiment of the present invention.

FIG. 4 illustrates a flow diagram for a method for providing access to assessment content via a portal in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

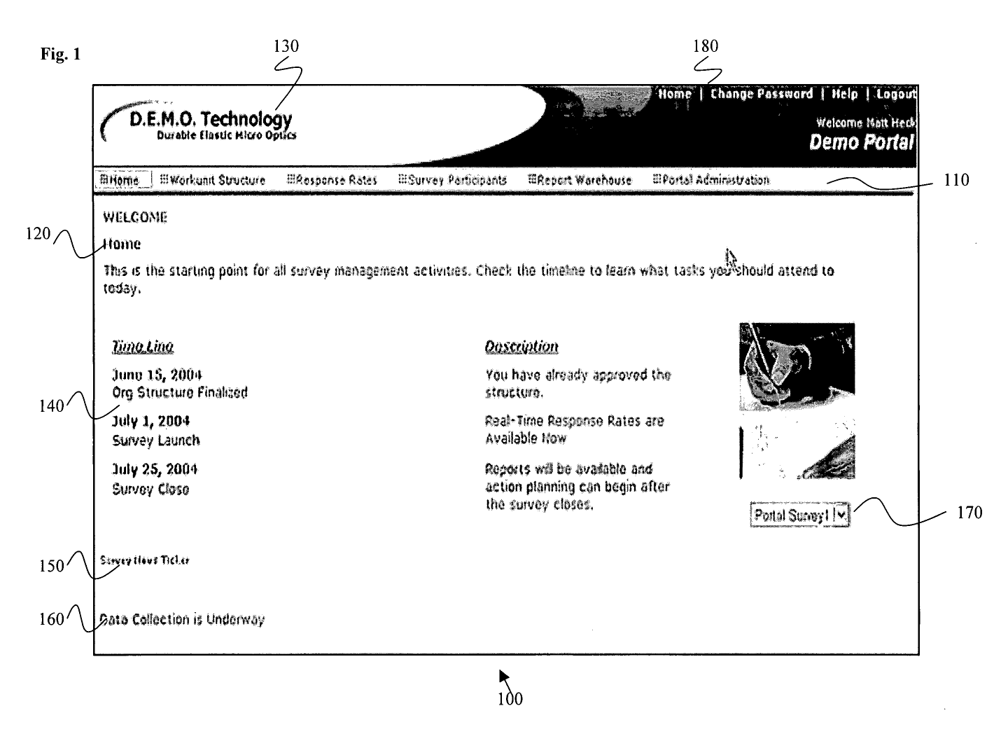

FIG. 1 illustrates a survey portal 100 used in accordance with an embodiment of the present invention. The portal 100 may be created to distribute assessment content reporting to managers and/or other personnel throughout an organization, for example. The portal 100 provides for a common interface or “one stop shopping” for one or more surveys and provides a plurality of tools and/or other resources for users. As shown in FIG. 1, the portal 100 may provide tools/resources using one or more tabs and/or links on the portal 100. Tabs or components may include a welcome or introductory page, hierarchy manager, response rates, report warehouse, and/or real time reporting, for example. Additional tabs may include resource materials, assessment builder, action planning resource bank, report ordering, and/or ad hoc reporting, for example. For purposes of illustration only, certain exemplary embodiments are described.

As shown in FIG. 1, the portal 100 may include a menu/tool bar 110, a message area 120, an identification banner 130, a general information area 140, a news ticker 150, a status indicator 160, a survey/assessment list 170, and a login menu 180, for example. As will be described further below, the portal 100 may be customized and/or configured for a particular organization, user, and/or content. For example, the identification banner 130, as well as menu bar 110, and content areas 120, 140, 150, 160 and/or 170 may be customized for an organization and/or user. The banner 130 helps to identify the organization, user, and/or content affiliated with the portal 100, for example. The message area 120 and general information area 140 provide information and resources to a viewer of the portal 100. In an embodiment, the message area 120 and/or general information area 140 may include a list of personal tasks for a user to complete, for example. The news ticker 150 provides a stream of updates and information. The status indicator 160 provides an indication of portal 100 activity/status to a user. A user may select from a list of assessment(s) (e.g., surveys, tests, reviews, feedback, and/or other assessments) via the assessment list 170. Tabs or options on the menu bar 110 provide a user with tools for managing the portal 100, configuring assessments administered via the portal 100, controlling access to the portal 100 and/or portal assessments, generating reports, etc.

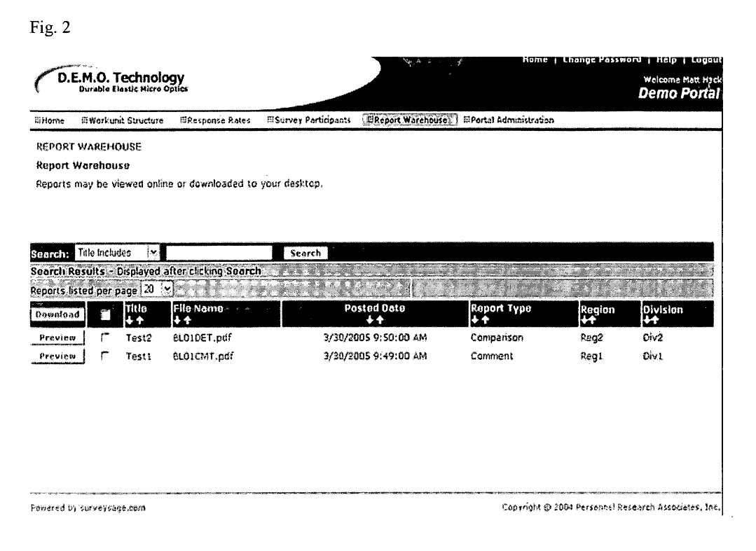

The portal 100 may be configured for users such as process owners, survey coordinators/liaisons (i.e., individuals who assist with the implementation of the survey process but do not have overall responsibility for the process), managers, employees/customers, and/or other roles. In an embodiment, review and confirmation of the hierarchy occurs within the portal 100. In an embodiment, options that are available to a user are based on that person's role and/or their level in the hierarchy, for example. For example, a survey owner for a region has access to all tabs and has access to all information for the region (e.g., may see the entire hierarchy and edit as needed, view all reports, see all response rates, etc.). Managers may have access to reports for groups that they oversee (i.e., their direct team and perhaps all groups that roll into that team). An example of a report warehouse for viewing and/or downloading reports via the portal 100 is depicted in FIG. 2.

The portal 100 may include a plurality of resources including a hierarchy manager, response rate tracker, report warehouse, and/or best practices database, for example. In an embodiment, the hierarchy manager is used to view and confirm a portal hierarchy. Survey owners and possibly survey coordinators may have access to the hierarchy manager. For example, survey owners may have full access to the entire hierarchy for their region. Survey coordinators may be given access to more limited segments of the hierarchy and/or may be restricted in the types of actions that they may take (e.g., may be allowed to change a headcount or manager name, but not allowed to move groups). Alternatively, survey owners may download spreadsheets and email the spreadsheets to survey coordinators rather than giving coordinators access to the hierarchy manager. Response rates may be used to track response rates for a “live” or active survey. Survey owners, survey coordinators, and/or managers may be given access to response rates, for example. Coordinators may be provided access to a portion of the hierarchy, for example. Managers may be allowed to track responses for their respective groups, for example. The report warehouse serves as a repository for reports once the response is generated. Access may be given to survey owners, survey coordinators, and/or managers, for example, to review reports at varying levels of the hierarchy. Additionally, the best practices database may provide resources on successful practices used by others as well as other suggestions to improve an organization and/or assessment scores, for example.

In an embodiment, portal content may be available in one or more languages. For example, portal content may be provided in English with an option for display in Spanish selected by a user. In an embodiment, a portal configuration may specify a default display language as well as other configuration parameters. In an embodiment, the portal 100 may be branded according to user and/or organization through use of indicia such as a logo, banner, color scheme, and/or graphic image.

In an embodiment, the portal 100 may be configured based on a hierarchy, such as an organizational, corporate, departmental, geographical, content-based, and other hierarchy. Access to the portal 100 may be governed by permissions according to the hierarchy and/or other criterion, for example. For example, the portal 100 may be configured with two tiers of permission for managers as well as roles for survey administrators/coordinators and a survey process owner. Based on a password, biometric, and/or other authenticator, an authorized user may access portions of the portal 100 appropriate for the user's role and the portion of the portal hierarchy for which the user has viewing privileges. For example, a response rate tab is designed for use by survey administrators/coordinators and the process owner, and such users will only see the parts of the organization for which the users have viewing and/or access permissions. Additional resources may be made available through the portal 100 as well.

Access to data and functions in the portal 100 may be restricted through hierarchy levels and paths and/or through specific permissions assigned to each user or group of users, for example. A hierarchy may be based on organization structure and/or other criteria, for example. In an embodiment, a user with permission at a given hierarchy level may view information at or below the hierarchy level but not above the hierarchy level. Permissions may be divided into activity sets, such as test management, scheduling, reporting, and/or hierarchy, for example. A user and/or group of users may be given all permissions within one or more activity set(s) or any subset of permissions.

In an embodiment, the portal 100 provides response rate functionality. The response rate tab allows survey coordinators to track returns and follow up with those areas in which responses are low. Online returns may be automatically updated and reflected via the portal 100. Paper survey returns may incur a delay to allow for receipt and scanning. Within the response rate tab of the portal 100, returns may be displayed by organizational structure, with basic drill down capabilities (e.g., see returns listed by business unit, with drill down by location), for example. In an embodiment, data to be viewed on the response rate tab/page may be configured before a survey is live. For example, data, such as total headcount, total sample, response rate, total completed, partially completed, hourly completed, salaried completed, etc., may be configured to be shown or hidden at the response rate tab. In an embodiment, a user may view response rate data via a hierarchy by drilling down through the hierarchy to view data. In an embodiment, a user may select a parent group to view data for the parent group and all groups below that parent group.

In an embodiment, the portal 100 provides reporting functionality, such as a report warehouse and ad hoc reporting capability. The report warehouse and ad hoc reporting tabs/options provide managers and/or other authorized users with broad access to reports, for example. Within the warehouse portion of the portal 100, managers and/or other authorized users may view and download PDFs or other documents generated from report data. Users may also request that any of these reports be created on the fly in another language for each of the languages requested by an organization. If a user has requested generation of a report, the user may search for his/her report(s) and download the report(s) via the portal, for example. The reporting area(s) of the portal 100 may provide one or more list(s) of reports based on certain arrangement(s) or criteria, for example. Within the ad hoc reporting functionality, managers and/or other users may also request different report types changing information that is displayed. Users may select the groups that they want displayed and/or other options to create a report in real time (i.e. “on the fly”). In an embodiment, rules may specify a minimum number of respondents in order to generate a report. In an embodiment, rules may be applied within a report but not across a set of requests. In another embodiment, rules may be applied across multiple requests.

In an embodiment, a collaboration tool may be used in addition to and/or in conjunction with the portal 100. The collaboration tool may be used for project management activities such as tracking milestones, reviewing and approving survey layouts, tracking open issues for resolution, storing documents such as a proposed, planning templates and invoices, and tracking other decisions/communications for a project. In an embodiment, the tool may be configured to automatically send an email and/or other alert to one or more users listing new/revised entries to the tool and/or portal 100. The tool may be configured to automatically send email according to a certain period and/or schedule, for example.

In an embodiment, the portal 100 may include action planning or best practices functionality, which may be a general action planning area and/or an action planning portion configured specifically for a particular user or group of users. Content provided via the action planning tab or link may include a compilation, data warehouse, or listing of “best practices” gathered from other users or leaders in an industry, for example. A user may review what other organizations have done in terms of improving their survey scores. Best practice results may be searched by different dimensions or items, for example. Best practices may provide a list of suggestions that a user may use to improve his/her/their scores. In an embodiment, the portal 100 may also include a general resources tab that allows a user to access a variety of document(s) to run a survey process and/or other general information.

Users may access the portal 100 to order surveys for an organization, for example. In addition to placing an order for survey(s), a user may view a status of an order and other tracking information. Surveys may be made available for administration and/or download via the portal 100.

As mentioned above, the portal 100 provides an ability to establish a hierarchy for an organization and/or group of users. In an embodiment, multiple hierarchies may be implemented at the portal 100. For example, portal 100 may be organized into a report group hierarchy and a location hierarchy. Additionally, different views of information may be provided within the same hierarchy. Using the hierarchy, access to data may be restricted by hierarchy level, view, and/or other criterion, for example.

Multiple views may be provided within a hierarchy via the portal 100. For example, rather than one path down through a hierarchy, multiple nodes may be defined on a hierarchy. A user's view of a hierarchy may then switch among the nodes. For example, marketing may report to corporate but may also be aligned with business units in the organization. Using multiple views, marketing may be placed with a business unit as well as with corporate for data access and report generation. Thus, components within a hierarchy may be linked in multiple ways to provide a variety of options for data viewing, data analysis, survey generation, and/or report generation, for example. Based on permissions, a user may switch between views to access data, for example. User and/or group access may differ not only by hierarchy but also by multiple views within the hierarchy and/or the presence of multiple hierarchies. Reporting may be configured and generated based on multiple hierarchies and/or views within one or more hierarchies as well. The portal 100 may facilitate reporting off of a hierarchy in multiple directions and/or relationships. Values within a hierarchy may be reassigned based on view without destroying the hierarchy.

An operator may build and/or manage a hierarchy using the portal 100 and assign viewing and/or modification permissions to user(s) based on the hierarchy, for example. Permissions may be assigned according to role and may be associated with a user or role via a lookup table or other correlation, for example. Selection of and access to data is protected through the portal 100 user interface. A user may access the portal 100 via a single user name and password and navigate through sites/information that the user has permission to access via the portal 100. Based on the identity and/or type of user and relevant permission/access level, a set of rules and/or logic access a database holding survey and report data and related information and provide data, reports, and/or tools to a user based on authorized access for that user, for example.

In an embodiment, a user may access a hierarchy builder/manager via the portal 100 to build a hierarchy for survey administration and reporting via the portal 100. A hierarchy builder allows an authorized user to view, modify, add, move, and/or sort hierarchy for portal 100 access.

Using the view option, an operator may select one of multiple hierarchy, drill up and/or down through a hierarchy, preview a hierarchy as it will look in a survey, and/or open/save a spreadsheet (e.g., a Microsoft® Excel spreadsheet) of the hierarchy. An operator may view an entire hierarchy and/or a portion of the hierarchy, as well as information regarding the hierarchy, such as headcounts, response, rates, system IDs, etc. For example, system IDs may represent internal unique identifiers for each report group in a hierarchy. A system ID may be recorded when a participant selects a report group in a survey or may be assigned as part of an employee directory attached to the hierarchy. System IDs may then be used to create criteria statement when creating reports. A system ID may be used to make changes to report groups on the portal 100 to help ensure that changes are made to the proper group. In an embodiment, a report group hierarchy may be organized according to report group name, report group number, and/or system ID.

Additionally, an operator may modify all or part of a portal 100 hierarchy. For example, an operator may select a work group and modify group properties such as group title, manager name, headcount, etc. Modifications to a group may be saved in the hierarchy. Additionally, one or more groups/subgroups from the hierarchy using the hierarchy builder.

An operator may add a new workgroup to a hierarchy using the hierarchy builder. To add a new group, a parent group may be selected, and the new group will fall under the selected parent group, for example. In an embodiment, information related to the new group may be input by the operator and/or automatically completed by the hierarchy builder. For example, group title, manager, and/or headcount may be completed. When an operator is satisfied with the new group, the group may be added to the hierarchy.

In an embodiment, an operator may navigate the hierarchy via the hierarchy builder to locate a group to be moved. Once the group has been located, the operator may navigate the hierarchy to locate the new parent group for the group to be moved. The group to be moved may be moved to its new parent group using a plurality of methods. For example, the identifiers of the group to be moved and the new parent group may be identified to move the group to its new location. Alternatively, a new location may be specified with respect to a group to move the group to the new location. The group to be moved may also be selected and dragging to its new parent group using a mousing device and a hierarchy builder interface, for example. In an embodiment, moving a group also moves groups falling under that group in the hierarchy to the new location.

The hierarchy builder may also offer sorting functionality to an authorized user. An authorized user may sort report groups in a hierarchy according to a certain order. Sort entry order may be specified by the user and/or by automatic rule(s) of the hierarchy builder. Sorting may be repeated for each group until a desired viewing order sequence is achieved.

In an embodiment, permissions for access, viewing, and/or editing may be set via the hierarchy builder and/or portal administration for the portal 100. For example, editing and/or viewing permissions may be based on the portal user's role.

Using the portal 100, a user may generate a report by defining a type of report to run, specifying which organization's data is to be used, and confirming the report configuration to launch the report. The user may also specify which comparison group or benchmark data is to be referenced in comparison to the report data. In an embodiment, selection of data may depend upon access permissions, for example. In an embodiment, report(s) may be loaded into a report warehouse for access via the portal 100. An authorized user may determine type(s) of document(s), such as standard reports, comment reports, paper invitations, etc., to be loaded to the report warehouse. In an embodiment, data may be translated for a report. In an embodiment, trending and/or mapping (e.g., historical mapping, comparison mapping, group or participant level mapping, etc.) may be performed using survey data and reported, for example.

Reports may be organized and/or accessed according to one or more tables, such as Microsoft® Access tables. For example, a user may create a coordinator list, a report list, and coordinator views for loading reports into the report warehouse. Information may be prepared and uploaded into the portal 100 for display and/or access via the report warehouse, for example. For example, the coordinator list includes a list of all report coordinators for at least a portion of the portal 100. The coordinator list may include coordinator name (e.g., a list of coordinators who will access reports via the portal 100), coordinator email or other contact information, and coordinator ID, for example. The report list may include a list of all documents to be seen in the report warehouse. For example, the report list may include document title(s), document file name(s), report ID(s), and/or report type(s) (e.g., standard report, comment report, paper invitation, etc.). A list of coordinator views may include a list of coordinators and corresponding reports to view, for example. For example, a coordinator views list may include coordinator email, coordinator ID, report file name, report ID, and/or report type. Reports and related information may be configured by an authorized user for display via the portal 100, such as via a report warehouse at the portal 100.

Portal administration allows a user to configure parameters such as a site access list, site activation dates, home page messages, ticker messages, and role permission maintenance. The site access list provides access to the portal 100 for specified user(s). In an embodiment, access list entries include name, email address or other identifier, and role (e.g., primary administrator, administrator, coordinator, and user). Different roles define different functions and/or levels of access to information via the portal 100. For example, a primary administrator may control all portal functions and assign privileges to administrator, coordinator and user roles. An administrator may control functions assigned by the primary administrator. A coordinator may control functions assigned by the primary administrator and administrator. For example, a user may only see menu options, portal tabs, etc., based on their role. Users may be invited to access the portal 100 by an administrator and may be provided with password(s) associated with different privilege levels to access the portal 100. Hierarchy viewing permissions may be set, and users may be added and/or deleted, for example. In an embodiment, user profile(s) may be maintained by an administrator and/or automatically by the portal 100 to govern access, search options, ordering, reporting, survey applicability, help, etc.

Additionally, a portal administrator may perform role permission maintenance via the portal 100. An administrator may select a role (e.g., primary administrator, administrator, coordinator, etc.) for which to set permissions. Then, one or more portal pages (e.g., welcome, hierarchy builder, report warehouse, etc.) may be selected with respect to the role. Permissions (e.g., viewing, editing, etc.) may be set for each portal page with respect to the role.

A portal administrator may also configure site activation dates. For example, an administrator may set open and close dates for each function of the portal 100, such as hierarchy builder, report warehouse, etc. An administrator may also edit text on a portal 100 welcome page and/or link pages on the portal 100 site (e.g., report warehouse, etc.). An administrator may also edit text for ticker messages displayed via the portal 100.

In an embodiment, an authorized user may configure survey participants via the portal 100. Participants may be added, deleted, and/or edited by name, email address, and/or other identification information, for example. Survey invitations may be sent to participants via the portal 100. Additionally, access information may be sent to participants via the portal 100. In an embodiment, users accessing the portal 100 may select from a plurality of languages for display of the portal 100, survey(s), report(s), data, and/or other information, for example.

In an embodiment, the portal 100 includes an assessment builder that allows an authorized user to generate and/or manage assessment(s) for completion via the portal 100. For example, assessments may be added, deleted, and/or edited. In an embodiment, assessments may be added from an archive and/or purchased, for example. In an embodiment, components used to form an assessment may be purchased from an assessment bank. Content and layout may be configured for one or more assessments, for example. Properties, such as assessment type (e.g., EOS, 360, selection, certification, other), header branding, support document options, display style, colors, available languages, and/or navigation options/style, may be configured for an assessment. Branching or control flow in an assessment may be configured based on question responses, demographic profile, hierarchy membership, etc. Scoring options may be set at an item, competency/dimension, and/or battery level, for example. In an embodiment, assessments may be linked together in a battery. Assessments in a battery may be completed in a certain order and/or in any order, for example. In an embodiment, prerequisites (e.g., previous assessments/scores, re-test time frames, date conditions, etc.) may be defined to enable a user to take an assessment. Once an authorized user and/or minimum requirements are satisfied with an assessment, the assessment may be published for distribution via the portal 100.

In an embodiment, assessment deployment may be managed such as by setting start/end dates for conducting assessment, sign-on type, maximum/minimum number of participants/seats, rater, role view permissions, terms, etc. Selection criteria, such as participant profile, demographics, testing location, etc., may be set to invite participants to the assessment, for example. In an embodiment, an assessment may be rendered for a participant on a browser via the portal 100, for example.

In an embodiment, the portal 100 may combine functionality found in a plurality of applications. The portal 100 may also serve as a conduit for access to individual applications. For example, the portal 100 may centralize access to a plurality of survey applications, such as SelectionSage™, SurveySage®, and 3SixtySage™. For example, candidate selection, test scheduling, test administration, reporting, account administration, and billing/use information may be facilitated via the portal 100. Tests may be administered according to a certain hierarchy, candidate profile, schedule, pre-screening, and/or other parameter, for example. Test scoring and reporting may also be facilitated via the portal 100.

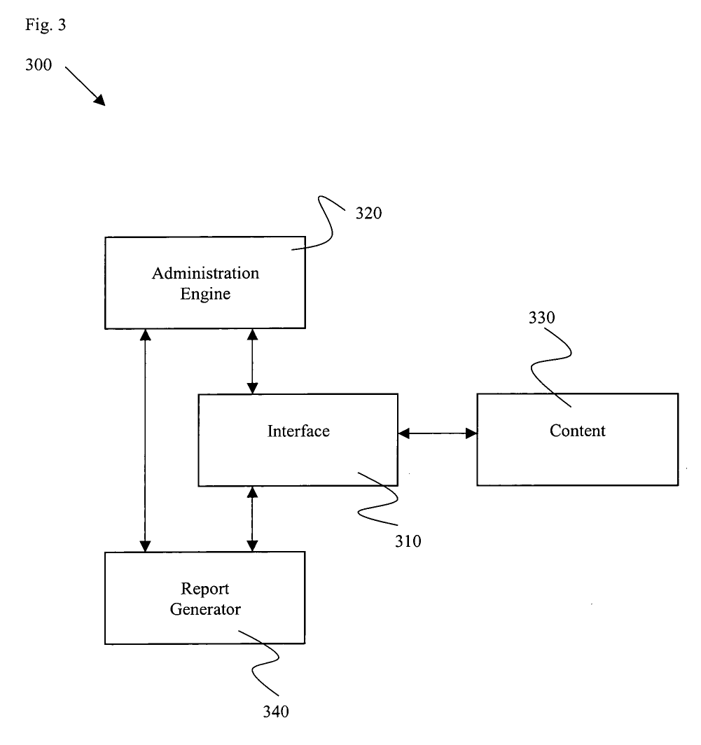

FIG. 3 illustrates another example of a portal 300 in accordance with an embodiment of the present invention. The portal 300 includes an interface 310, an administration engine 320, content 330, and a report generator 340. The interface 310 may be used to access the portal 300. In an embodiment, the interface 310 is a centralized access point or portal to content and services. In an embodiment, the interface 310 may be customized by organization and/or by user, for example. Content 330, such as survey content, test content, review content, feedback content, and/or other assessment content, may be available to an authorized user via the interface 310. In an embodiment, data transmitted into and out of the portal 300 may be encrypted and/or otherwise protected and verified, for example.

The administration engine 320 may be used to manage all or part of the portal 300. For example, an authorized user may manage configuration, access/modification permissions, content construction, and/or report construction of the portal 300 via the administration engine 320. In an embodiment, the portal 300 may be organized based on one or more hierarchies via the administration engine 320. One or more views of a hierarchy may be configured via the administration engine 320. Access to content 330, such as access to surveys, and access to reports, such as access to reports generated from survey results, may be configured by the administration engine 320, for example. Formatting for content 330 and/or reports may be determined using the administration engine 320, for example.

The report generator 340 may be used to generate reports based on the content 330, for example. The report generator 340 may be configured to automatically generate reports based on the content 330, and/or to manually generate reports on command from an authorized user. In an embodiment, reports may be dynamically generated in real time from content data via the report generator 340.

In an embodiment, the portal 300 may also include informational resources, such as a best practices database, survey/practice improvement guidelines, and/or other informational/educational resources. In an embodiment, the portal 300 may also include a message board allowing users to post and/or exchange messages regarding content 330, reports, and/or information resources, for example.

The portal 300 serves as a centralized, controlled access point by which organizations may provide content, administer assessments, such as tests, surveys, reviews, questionnaires, and/or other assessments, and provide results in a report, spreadsheet, data table, and/or other feedback, for example. The portal 300 may administer assessment(s) to an individual and/or to a group, for example. The portal 300 may administer the same assessment and/or different assessments to individuals in a group. Certain embodiments provide a tiered assessment system allowing multiple administrators and/or participants. Certain embodiments provide task scheduling capability for users and/or administrators to schedule assessments and/or other reviews.

Thus, for example, the portal 300 may be configured to provide one or more surveys for an organization as well as additional resources, such as a best practices reference, to allow the organization to administer survey(s), analyze response(s), and provide reporting and additional resources based on response(s). Surveys and/or analysis tools may be organized via one or more hierarchies at the portal 300. Access to activity such as adjusting a survey, taking a survey, viewing results, and/or generating reports may be limited based on hierarchy, user, and/or role, for example. Additionally, the portal 300 may interface with one or more additional applications/systems to provide information and/or functionality via the portal 300.

In an embodiment, the portal 300 serves as a conduit to one or more other systems, such as a real-time, electronic survey processing and reporting system described in, for example, U.S. patent application Ser. No. 10/844,067, entitled “Method and Apparatus for Survey Processing”, by William Macey et al., filed on May 11, 2004, and/or a test administration system described in, for example, U.S. patent application Ser. No. 11/221,672, entitled “Method and Apparatus for Test Administration”, by Mathew Heck et al., filed on Sep. 8, 2005, which are herein incorporated by reference in their entirety.

In an embodiment, the portal 300 and other systems may be hosted via an application service provider (ASP) platform. The ASP hosts and manages the application(s) and allows users to access services via a network (e.g., via the Internet through a web browser). Content and services may be quickly and easily delivered using the ASP. Using an ASP allows participating organizations to save money that would be used to fund, build and maintain a network infrastructure for the portal 300 and other services. Automatic or manual software upgrades may be transparent to users of the portal 300 via the ASP. In an embodiment, the interface 310 for the portal 300 may be customized according to organization and/or user via the ASP. In an embodiment, the portal 300 may include content 330 and/or services for a plurality of organizations, and each organization may have a custom interface 310 to access its portion of the content and/or services via an ASP portal 300, for example.

Certain embodiments of a portal may be implemented using hardware, software, and/or firmware, for example. In an embodiment, a portal may be implemented as a set of instructions on a computer-readable medium. For example, a portal may be implemented using a portal routine configured to coordinate access to assessment content, such as survey, test and/or other assessment content, through a centralized access portal. A content routine may be configured to provide assessment content to an authorized user via the portal. Additionally, the content routine may be configured to administer an assessment to an authorized user, for example. A reporting routine may be configured to generate and/or display reports based on the assessment content. An administration routine may be configured to manage the portal, for example. In an embodiment, additional routines may be configured to provide additional functionality and/or resources for a portal, for example.

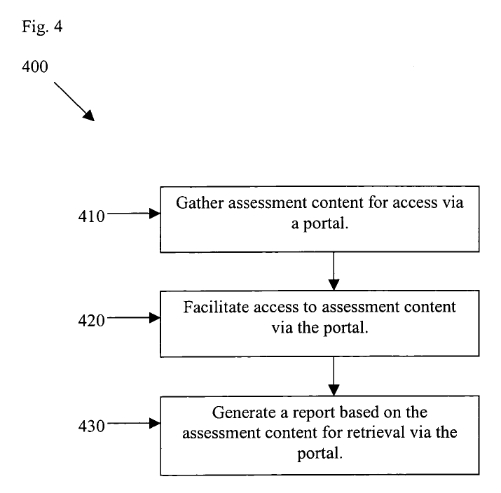

FIG. 4 illustrates a flow diagram for a method 400 for providing access to assessment content via a portal in accordance with an embodiment of the present invention. At step 410, assessment content is gathered for access via a centralized access portal, such as the portal 100 and/or portal 300. For example, assessments such as surveys, tests, reviews, questionnaires and/or other assessments may be loaded for access via the portal. Additionally, resources, such as data analysis tools, reporting tools, and/or general informational resources (e.g., best practices guidelines, etc.) may be loaded for access via the portal. In an embodiment, an authorized user may add content for access via the portal. In an embodiment, assessment content, such as surveys, tests, etc., may be constructed via the portal. Assessment construction may be facilitated by one or more templates, content libraries, content wizards, and/or custom designers, for example.

At step 420, access to the assessment content is facilitated via the portal. For example, user and/or organizational accounts may be set via the portal to access the assessment content and related services. Access to the portal may be controlled by one or more criterion, such as user identification, role, content, and/or organization. Assessment content and/or access to assessment content may be organized according to a hierarchy or hierarchies, for example. In an embodiment, a hierarchy may include one or more views with which to access assessment content and/or services. In an embodiment, the portal may be customized for a particular organization, user, and/or assessment, for example. In an embodiment, usage statistics and/or current activity, for example, may be tracked via the portal. Assessment participants, access permissions, and/or other parameters may be configured for the portal and its content. Users may be notified via email or other method to access the portal and/or may self-register on the portal site. For example, survey participants may be notified via email to participate in a survey via the portal.

Additionally, users may access the portal via external application(s). That is, the portal may be integrated with and/or in communication with another application. Users may access the portal when routed from another application passing user credentials/authentication information, for example. For example, a user may launch a test from the portal via an applicant tracking system.

At step 430, one or more reports are generated based on the assessment content for retrieval via the portal. Reports such as summary reports, trending reports, and/or other data/statistical analysis may be generated based on assessment content and/or results of assessment content, for example. Reports may be organized, filtered, and/or analyzed based on one or more criterion, such as country, organization, geography, manager rating, stock rating, review rating, average performance rating, job, tenure, benchmark, etc. Reports may be generated automatically and stored for later viewing and/or may be generated substantially in real time for viewing by an authorized user. Reports may be generated using predetermined templates and/or dynamic, customizable formats, for example. Reports may be run on demand and/or according to a schedule, for example. In an embodiment, an authorized user may generate an action plan based on assessment content and/or report results, for example.

In an embodiment, reports may be transmitted, such as by electronic mail and/or facsimile, to an authorized user as well as being viewable via the portal. In an embodiment, report data may be fed into another application for further analysis and/or processing, for example. In an embodiment, a report and/or raw data may be exported to another document and/or application, such as a spreadsheet (e.g., Microsoft® Excel) or database (e.g., Microsoft® Access or SQL). Reports and/or data may be warehoused for further access and/or use. In an embodiment, assessment data may be compared to benchmark or other comparison data for report generation and/or other display of results, for example. In an embodiment, an authorized user may confirm a report before the report is made available for access via the portal.

Thus, certain embodiments provide a portal facilitating centralized, secure access to assessment content, results, and/or services, for example. Certain embodiments allow administration of assessments, such as surveys, tests, reviews, feedback, and/or other assessment, and generation of real-time results via a portal. A portal may be customized to fit a particular organization, user, and/or assessment, for example. A portal may also serve as a resource for additional content/services, such as best practice guidelines, informational resources, action plans, and/or other information. Certain embodiments include configurable assessment capabilities as well as dynamic reporting capabilities to provide fast results with easy-to-use data reports, for example. Certain embodiments provide an administration and access structure which allows a user to create a system tailored for the unique complexities of the user's organization. Certain embodiments allow an authorized user to organize content and/or services according to one or more hierarchies and one or more views within each hierarchy.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An assessment content and services portal, said portal comprising:
an interface for access to assessment content at a portal;
an administration engine for managing said portal;
assessment content made available to a user via said interface at said portal; and
a report generator for generating reports based on said assessment content.

2. The portal of claim 1, wherein said administration engine facilitates at least one of configuration, access permission, content construction, and report construction.

3. The portal of claim 1, wherein said assessment content comprises at least one of a survey, a test, a review, and a feedback questionaire.

4. The portal of claim 1, wherein said assessment content further comprising informational resources, wherein said information resources include best practices.

5. The portal of claim 1, wherein said interface is customized based on at least one of organization, user, and content.

6. The portal of claim 1, wherein said portal comprises a web-based portal.

7. A method for providing assessment content using a portal, said method comprising:
gathering assessment content for access via a centralized access portal;
facilitating access to said assessment content via said centralized portal; and
generating real-time reporting related to said assessment content for retrieval via said centralized portal.

8. The method of claim 7, further comprising controlling accessing to said centralized portal based on at least one criterion.

9. The method of claim 8, wherein said at least one criterion includes at least one of user, role, organization, and content.

10. The method of claim 7, further comprising organizing said assessment content according to a hierarchy.

11. The method of claim 10, wherein said hierarchy includes multiple views.

12. The method of claim 10, wherein said hierarchy includes multiple hierarchies.

13. The method of claim 7, wherein said assessment content includes at least one of survey content, test content, review content, and feedback content.

14. The method of claim 7, wherein said centralized portal comprises a portal customized for an organization.

15. The method of claim 7, wherein said centralized portal comprises a web-based portal.

16. A computer-readable medium having a set of instruction for execution on a computer, said set of instructions comprising:
a portal routine configured to coordinate access to assessment content through a centralized access portal;
a content routine configured to provide assessment content to an authorized user via said portal;
a reporting routine configured to generate a report based on said assessment content via said portal; and
an administration routine configured to allow management of said assessment content via said portal.

17. The set of instructions of claim 16, wherein said administration routine allows an authorized user to set one or more privilege levels granting varying levels of access.

18. The set of instructions of claim 16, wherein said administration routine controls access to said portal based on at least one of user, role, organization, and content.

19. The set of instructions of claim 16, wherein said administration routine configures said assessment content according to at least one hierarchy and at least one view.

20. The set of instructions of claim 16, wherein said assessment content includes at least one of survey content, test content, review content, feedback content, and informational resources.
